(19) United States
(12) Patent Application Publication
(10) Pub. No.: US 2024/0334402 A1
(43) Pub. Date: Oct. 3, 2024

(54) METHOD AND APPARATUS FOR MITIGATING IDC PROBLEM IN NEXT-GENERATION MOBILE COMMUNICATIONS

(71) Applicant: SAMSUNG ELECTRONICS CO., LTD., Suwon-si (KR)

(72) Inventor: Sangbum KIM, Suwon-si (KR)

(21) Appl. No.: 18/618,923

(22) Filed: Mar. 27, 2024

(30) Foreign Application Priority Data
Mar. 27, 2023 (KR) 10-2023-0039732

(51) Int. Cl. H04W 72/0446; H04W 48/16; H04W 72/0457

(52) U.S. Cl. CPC H04W 72/0446; H04W 48/16; H04W 72/0457

(57) ABSTRACT

The present disclosure relates to a 5G or 6G communication system for supporting a higher data transmission rate. The present disclosure provides a method and apparatus of UE for supporting a higher date transmission rate. The method of UE comprises: receiving, from a base station, cell group configuration information including first information indicating a maximum number of uplink (UL) slots for denying an UL transmission; counting a number of denied UL slots within a same cell group; and in case that the counted number of denied UL slots is less than the maximum number of the UL slots indicated by the first information, denying the UL transmission in a UL slot.

### CROSS-REFERENCE TO RELATED APPLICATION

This application is based on and claims priority under 35 U.S.C. § 119 to Korean Patent Application No. 10-2023-0039732, filed on Mar. 27, 2023, in the Korean Intellectual Property Office, the disclosure of which is herein incorporated by reference in its entirety.

### BACKGROUND

### 1. Field

The present disclosure relates to operations of a UE and a base station in a mobile communication system. More specifically, the present disclosure relates to a method for reporting an in-device coexistence (IDC) problem in a communication system and an apparatus capable of performing the same.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to solve the above-mentioned problems, and an aspect of the disclosure is to provide a method and an apparatus for controlling the transmission power of each communication module to control interference which may occur between communication modules in a wireless communication system.

In accordance with an aspect of the disclosure, a method performed by a user equipment in a wireless communication system is provided. The method includes receiving, from a base station, cell group configuration information including first information indicating a maximum number of an uplink (UL) slot for denying an UL transmission; counting a number of denied UL slots within a same cell group; and in case that the counted number of denied UL slots is less than the first information, determining to deny any transmission in the UL slot.

In accordance with another aspect of the disclosure, a method performed by a base station in a wireless communication system is provided. The method includes generating cell group configuration information including first information indicating a maximum number of an uplink (UL) slot for denying an UL transmission; transmitting, to a user equipment (UE), the cell group configuration information including the first information; and in case that a counted number of denied UL slots is less than the first information, skipping to receive an UL transmission, wherein the number of denied UL slots is counted within a same cell group.

In accordance with another aspect of the disclosure, a user equipment in a wireless communication system is provided. The user equipment includes a transceiver and a controller, wherein the controller is configured to receive, from a base station, cell group configuration information including first information indicating a maximum number of an uplink (UL) slot for denying an UL transmission, count a number of denied UL slots within a same cell group, and in case that the counted number of denied UL slots is less than the first information, determine to deny any transmission in the UL slot.

In accordance with another aspect of the disclosure, a base station in a wireless communication system is provided. The base station includes a transceiver and a controller, wherein the controller is configured to generate cell group configuration information including first information indicating a maximum number of an uplink (UL) slot for denying an UL transmission, transmit, to a user equipment (UE), the cell group configuration information including the first information, and in case that a counted number of denied UL slots is less than the first information, skip to receive an UL transmission, wherein the number of denied UL slots is counted within a same cell group.

The disclosure is advantageous in that a UE may report improved IDC-related information and preferred solutions.

More specifically, the disclosure is advantageous in that an IDC problem may be reported in detail at the BWP level, and an autonomous denial function for NR may be introduced, thereby efficiently solving the IDC problem.

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

The above and other aspects, features, and advantages of certain embodiments of the disclosure will be more apparent from the following description taken in conjunction with the accompanying drawings, in which:

FIG. 1A illustrates a structure of a next-generation mobile communication system according to an embodiment of the present disclosure;

FIG. 1B illustrates a flowchart of processes in which a UE reports predetermined information to a base station so as to report preferred items in a mobile communication system according to an embodiment of the present disclosure;

FIG. 1C illustrates IDC according to an embodiment of the present disclosure;

FIG. 1D illustrates a frequency band adjacent to ISM band among frequency bands used for mobile communication in 3GPP according to an embodiment of the present disclosure;

FIG. 1E illustrates a flowchart of processes in which predetermined IDC information is reported to a base station in a mobile communication system according to an embodiment of the present disclosure;

FIG. 1F illustrates a method for operating a BWP in a next-generation mobile communication system according to an embodiment of the present disclosure;

FIG. 1G illustrates a case in which the effect of autonomous denial varies depending on BWP according to an embodiment of the present disclosure;

FIG. 1H illustrates a first method for calculating the autonomous denial slot according to an embodiment of the present disclosure;

FIG. 1I illustrates a second method for calculating the autonomous denial slot according to an embodiment of the present disclosure;

FIG. 1J illustrates a third method for calculating the autonomous denial slot according to an embodiment of the present disclosure;

FIG. 1K illustrates a first method for calculating the autonomous denial validity time according to an embodiment of the present disclosure;

FIG. 1L illustrates a second method for calculating the autonomous denial validity time according to an embodiment of the present disclosure;

FIG. 1M illustrates a third method for calculating the autonomous denial validity time according to an embodiment of the present disclosure; and

FIG. 1N illustrates a flowchart of UE operations according to an embodiment of the present disclosure;

FIG. 1O illustrates a flowchart of base station operations according to an embodiment of the present disclosure;

FIG. 1P illustrates an internal structure of a UE according to an embodiment of the present disclosure; and

FIG. 1Q illustrates a configuration of a base station according to an embodiment of the present disclosure.

### DETAILED DESCRIPTION

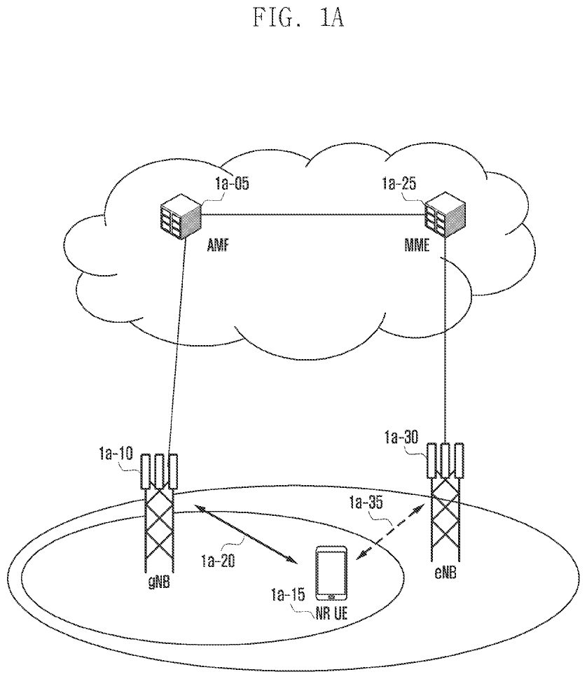

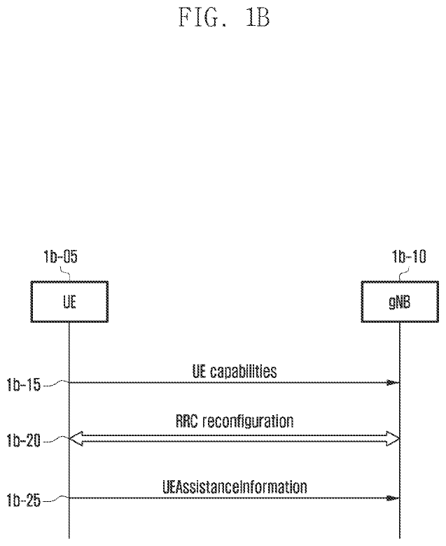

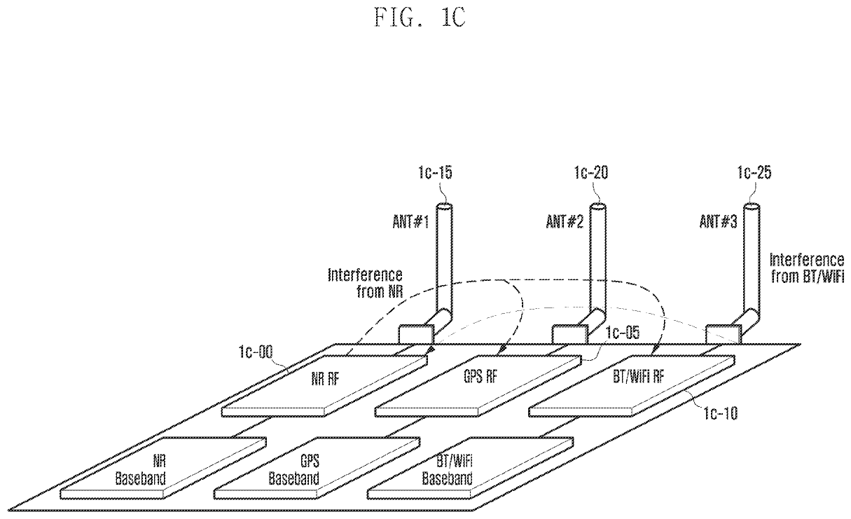

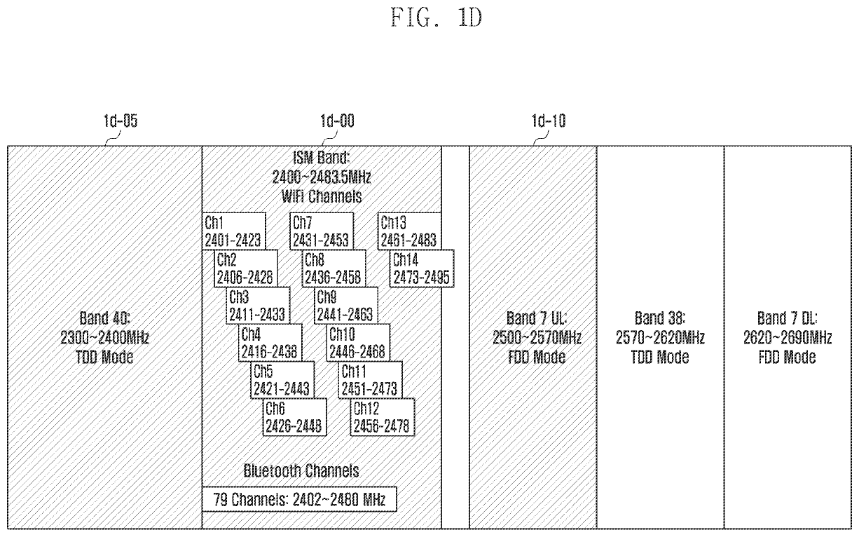

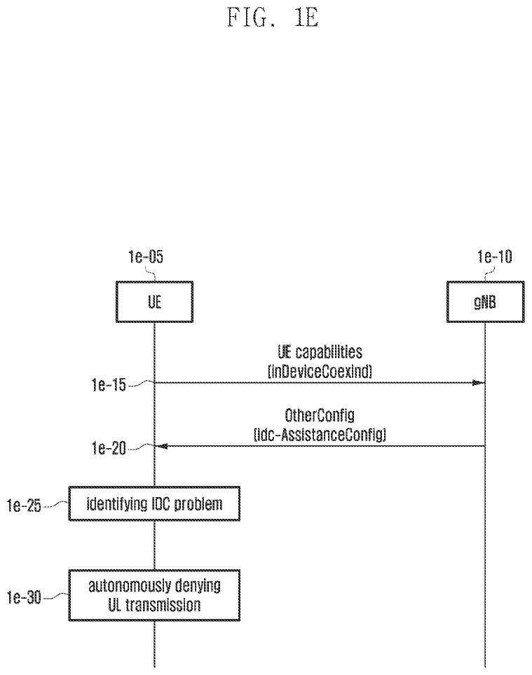

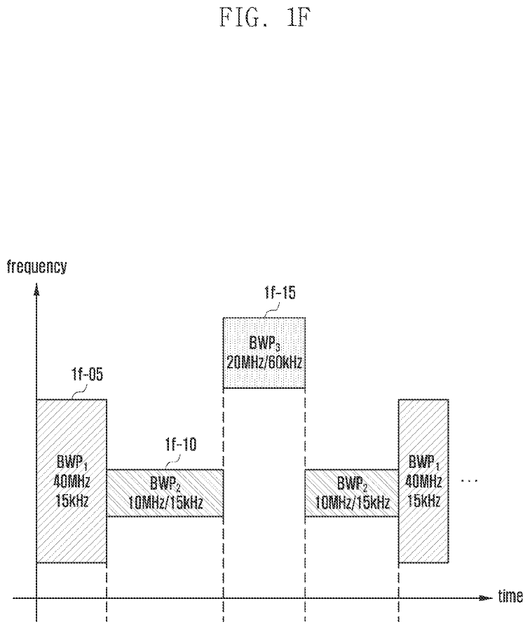

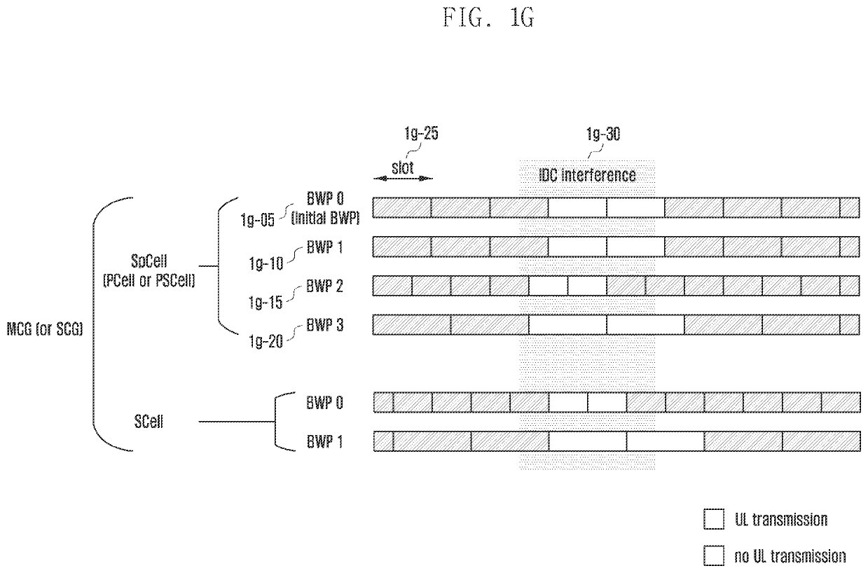

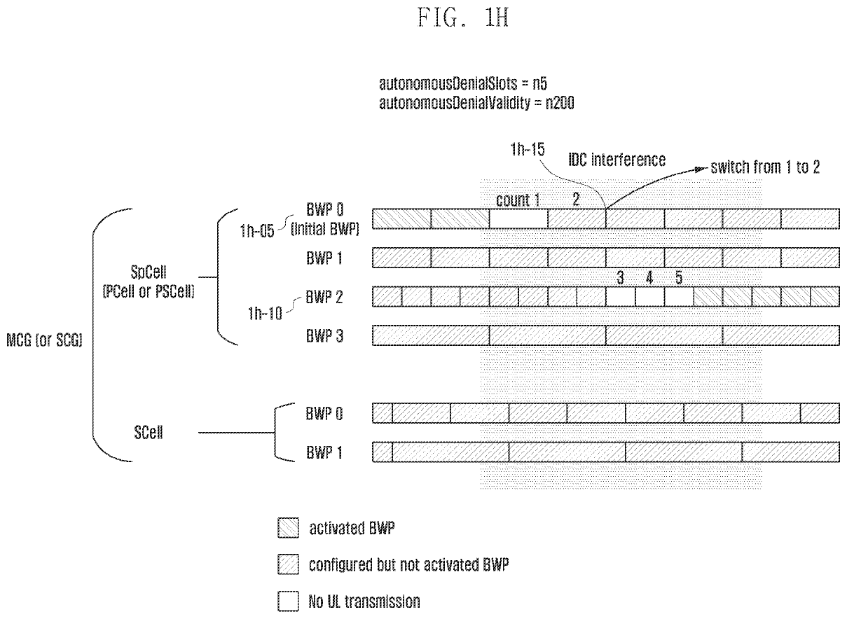

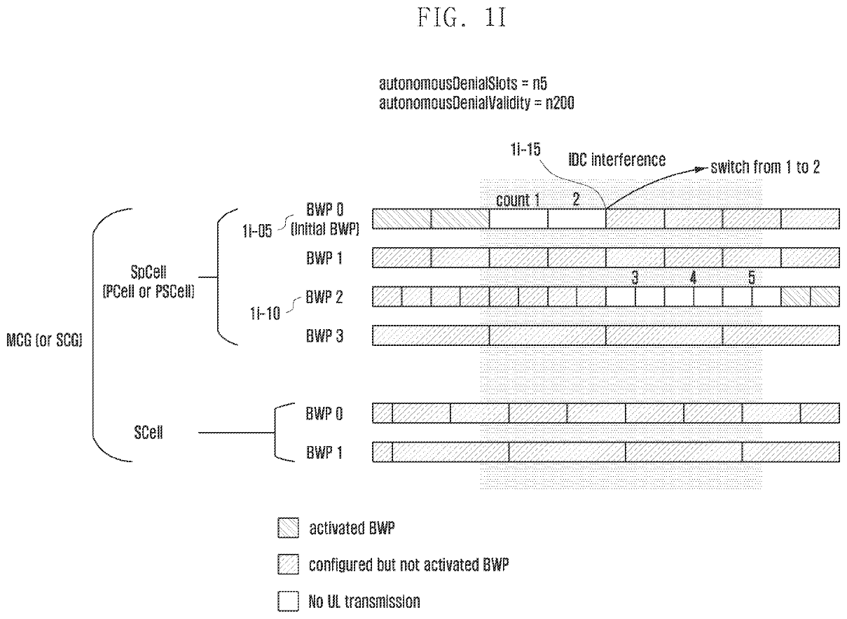

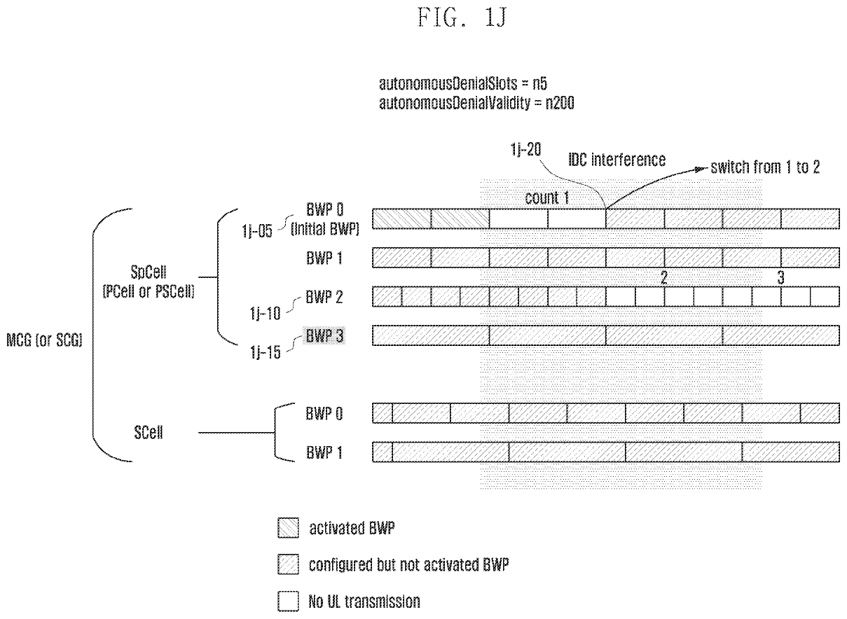

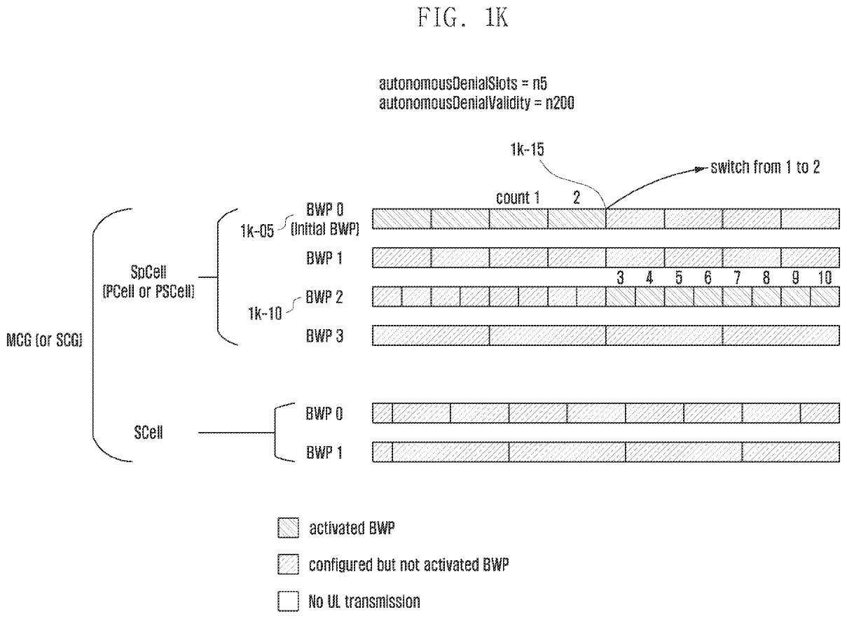

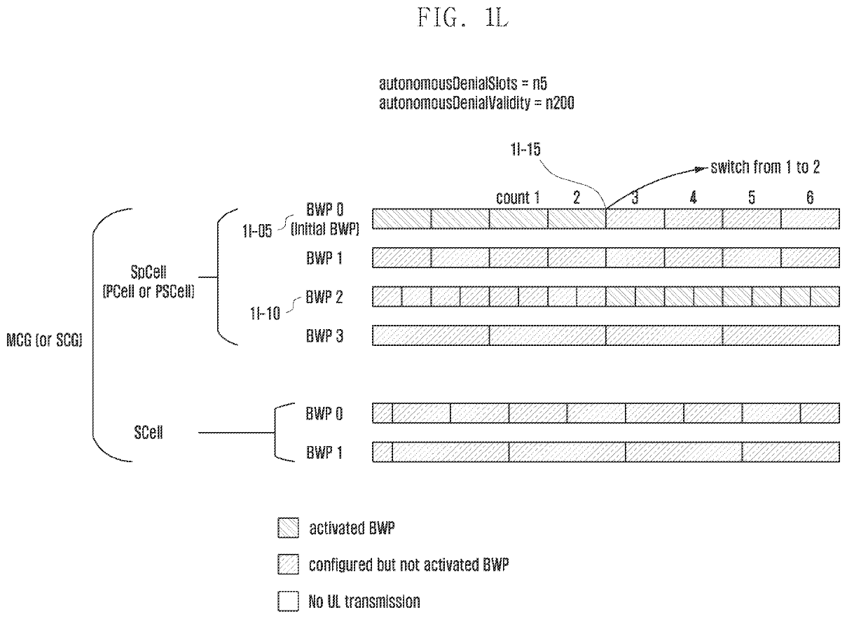

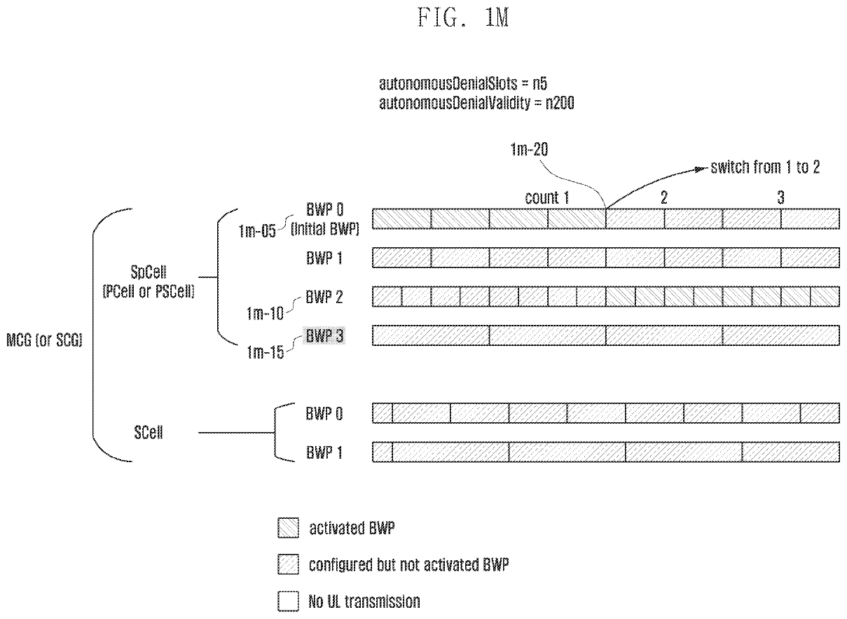

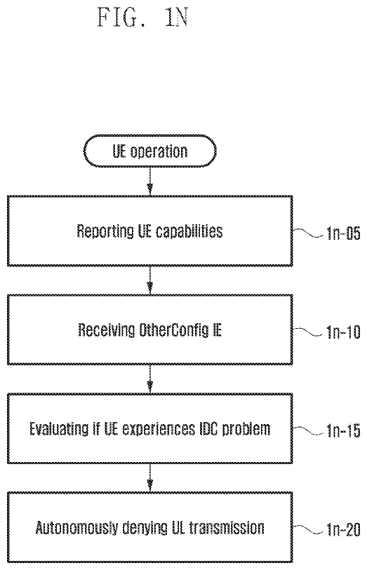

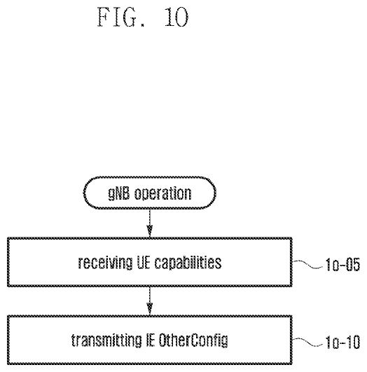

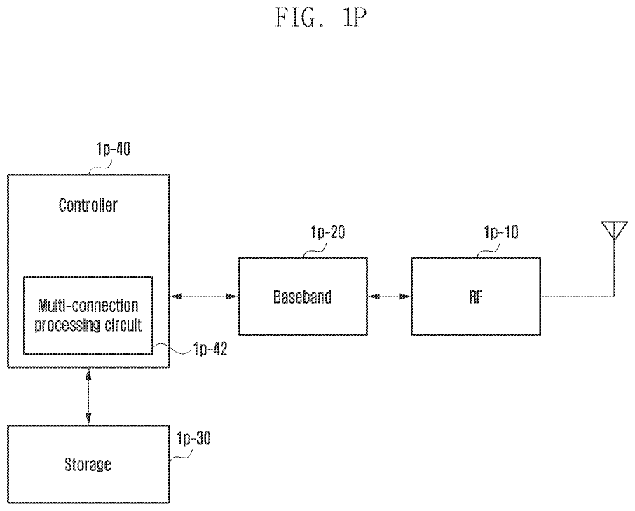

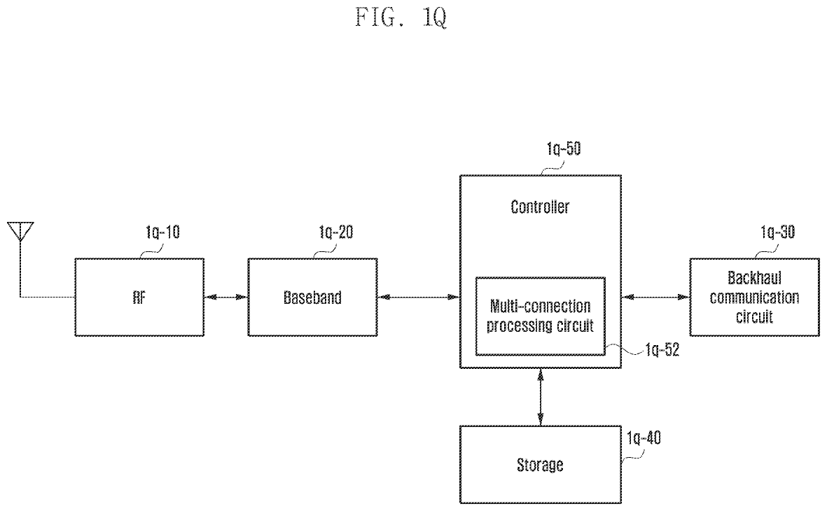

FIGS. 1A through 1Q, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

FIG. 1A illustrates a structure of a next-generation mobile communication system according to an embodiment of the present disclosure.

Referring to FIG. 1A, as illustrated, the radio access network of the next-generation mobile communication system (new radio (NR)) includes a new radio node B (hereinafter, referred to as gNB) 1a-10 and an AMF 1a-05 (New radio core network). The new radio user equipment (hereinafter, referred to as NR UE or terminal) 1a-15 may access an external network through the gNB 1a-10 and the AMF 1a-05.

In FIG. 1A, the gNB 1a-10 may correspond to an existing LTE system's evolved node B (eNB). The gNB 1a-10 may be connected to the NR UE 1a-15 through a radio channel and may provide more excellent services than existing nodes B (1a-20).

In a next-generation mobile communication system, all user traffic may be serviced through a shared channel, thereby necessitating a device for aggregating and scheduling state information such as the buffer state of UEs, the available transmission power state, and the channel state, and the gNB 1a-10 may handle this. A gNB may commonly control multiple cells. In order to implement super-fast data transmission compared with existing LTE, the maximum bandwidth may exceed the existing one, and orthogonal frequency division multiplexing (OFDM) may be used as the radio access technology, which may be additionally combined with a beamforming technology. In addition, an adaptive modulation & coding (hereinafter, referred to as AMC) scheme may be applied such that the modulation scheme and the channel coding rate are determined according to the UE's channel state.

The AMF 1a-05 may perform functions such as mobility support, bearer configuration, and quality of service (QOS) configuration. The access and mobility function (AMF) 1a-05 is a device in change of not only a UE mobility management function, but also various control functions, and may be connected to multiple base stations. In addition, next-generation mobile communication systems may interwork with existing LTE systems, and the AMF 1a-05 may be connected to a mobility management function (MME) 1a-25 through a network interface. The MME 1a-25 may be connected to an existing base station (eNB 1a-30). A UE that supports LTE-NR dual connectivity (EN-DC) may transmit/receive data while maintaining connection not only to the gNB, but also to the eNB (1a-35).

FIG. 1B illustrates a flowchart of processes in which a UE reports predetermined information to a base station so as to report preferred items in a mobile communication system according to an embodiment of the present disclosure.

In an NR mobile communication system, a terminal (or UE) may report items preferred thereby, based on the current configuration, to a base station (or gNB). For example, the UE may report at least one of preferred delay budget, deceased power consumption preference (UE power preference), decreased heating preference (overheating assistance), or IDC assistance (IDC problem reporting and referred solutions) to the base station.

Upon receiving the report of preferred items, the base station may trigger reconfiguration in response thereto. For example, upon receiving a report that decreased power consumption, deceased delay, and decreased heating are preferred, the base station may decrease or increase the DRX cycle so as to make reconfiguration.

The UE may report the preferred delay budget and the overheating assistance to the base station. In addition, the UE may report reconfiguration items preferred to reduce heating or power consumption in more detail. In this regard, the maximum number of secondary cells (SCell) preferred by the UE, the aggregated BW (frequency bandwidth), and the maximum number of MIMO layers may be indicated.

A procedure for reporting the preferred items is as follows.

Firstly, in operation 1b-15, the UE 1b-05 may report to the gNB 1b-10 that the UE 1b-05 is capable of reporting each of the above-mentioned items.

In operation 1b-20, the base station 1b-10 may configure, based on the capability information, the UE to be able to report each of the preferred items to the base station at a necessary timepoint.

In operation 1b-25, the UE 1b-05 may report items preferred thereby to the base station at a necessary timepoint by using a UEAssistanceInformation message.

FIG. 1C illustrates in-device coexistence (IDC) technology according to an embodiment of the present disclosure.

The IDC refers to a technology for minimizing interference occurring between multiple communication modules inside a device. Recently, UEs have various functions and have various communication modules for supporting the same. For example, the communication modules may include not only an NR communication module 1c-00, but also a GPS module 1c-05, a short-range communication module 1c-10 such as Bluetooth and wireless LANs, and the like. Such modules transmit/receive data through antennas 1c-15, 1c-20, and 1c-25 connected thereto, respectively.

Respective communication systems use different frequency bands, but if communication modules use adjacent bands, interference may occur therebetween. This is because transmitted/received signals cannot be separately ideally between bands. Particularly, each communication module and an antenna connected thereto are included in one terminal device and thus are positioned at a substantially short distance. Therefore, a substantial intensity of interference with each other may occur.

Therefore, in order to mitigate such interference, it is necessary to control the transmission power between communication modules. For example, when the short-range communication module 1c-10 (for example, Bluetooth or wireless LANs) attempts to receive data in the NR uplink, signals transmitted by the NR communication module 1c-00 may interfere with the short-range communication module. In addition, NR uplink signals may interfere with other NR frequencies or frequencies of other mobile communication systems.

In order to mitigate this, the uplink maximum transmission power of the NR communication module may be limited to control the amount of interference. Alternatively, operations of the NR communication module may be stopped temporarily, thereby removing the amount of interference power affecting the short-range communication module. To the contrary, the short-range communication module 1c-10 may interfere with signals received by the NR communication module 1c-00 in the NR downlink.

FIG. 1D illustrates a frequency band adjacent to the industrial scientific and medical (ISM) band among frequency bands used for mobile communication in 3GPP according to an embodiment of the present disclosure.

It is clear that, when a mobile communication cell uses Band 40 1d-05, severe interference occurs if the wireless LAN uses channel no. 1, and when the mobile communication cell uses Band 7 1d-10, severe interference occurs if the wireless LAN uses channel no. 13 or 14. Therefore, there is a need for a scheme wherein, if such interference occurs, the same is avoided appropriately.

In the new radio (NR), according to the base station configuration, the UE may report a UEAssistanceInformation message to the base station, the message containing NR frequency information (affectedCarrierFreqList field) affected by the IDC problem, NR frequency information (affectedCarrierFreqCombList field) undergoing the IDC problem due to inter-modulation distortion and harmonics of uplink NR signals configured by carrier aggregation (CA), or heterogenous communication module information (for example, GPS, BT, WLAN, and the like).

The disclosure provides a method in which a UE reports improved IDC-related information and preferred solutions.

Particularly, the disclosure provides a method for reporting the IDC problem between 3GPP and non-3GPP systems in the MR-DC scenario, a method for reporting the IDC problem in more detail at the BWP or PRB level compared with the prior art, a method for reporting a TDM-based solving method preferred by the UE, a method for introducing an autonomous denial function for the NR, and a method for improving the SON/MDT in consideration of the IDC problem. In addition, new UE capability information and configuration information are introduced for the same. The autonomous denial function refers to a technology wherein the UE autonomously pauses uplink transmission, which is expected to cause the IDC problem, for a predetermined period of time.

FIG. 1E illustrates a flowchart of processes in which predetermined in-device coexistence (IDC) information is reported to a base station in a mobile communication system according to an embodiment of the present disclosure.

In operation 1e-15, the UE 1e-05 may report to the gNB 1e-10 that the same is capable of reporting the predetermined IDC information. The UE 1e-05 may report an indicator indicating the capability to the gNB 1e-10. The capability to report IDC information may be indicated in detail and reported to the gNB 1e-10. For example, the UE 1e-05 may report whether an FDM or TDM-based solving method preferred by the UE can be reported, whether DRX configuration information preferred by the UE can be reported with regard to each cell group (CG) or DRX group, whether the frequency range which is affected by the IDC problem, or which affects the IDC problem, can be reported at the BWP level, whether the frequency range which is affected by the IDC problem, or which affects the IDC problem, can be reported at the PRB level, or whether the autonomous denial function is supported. Each piece of UE capability information may be considered as optional with a signal or optional without a signal.

In operation 1e-20, the gNB 1e-10 may send a predetermined IE (idc-AssistanceConfig) to the UE 1e-05 so as to make configuration, through a predetermined indicator, such that the UE 1e-05 can report the predetermined information to the gNB 1e-10.

After the IE is configured, the fact that information regarding the NR frequency that undergoes the IDC problem or uplink carrier aggregation is configured means that the UE 1e-05 can report that the IDC problem due to inter-modulation distortion/harmonics from the NR frequency occurred in other NR frequencies or other communication modules. Particularly, the IE may include a list of frequencies that can be reported, among NR frequencies undergoing the IDC problem. The list is contained in a CandidateServingFreqListNR IE, and each frequency belonging to the list is indicated by an ARFCN-ValueNR IE which indicates one center frequency. Frequencies that do not belong to the list may not be reported, even if the same undergoes the IDC problem. If the IE is not provided, the UE reports, to the gNB, information regarding the frequency that undergoes the IDC problem in the NR frequency supported by the UE.

The idc-AssistanceConfig may additionally include the following configuration information:

For example, the same may include a configuration indicator indicating whether an FDM or TDM-based solving method preferred by the UE can be reported, a configuration indicator indicating whether DRX configuration information preferred by the UE can be reported with regard to each cell group (CG) or DRX group, a configuration indicator indicating whether the frequency range which is affected by the IDC problem, or which affects the IDC problem, can be reported at the BWP level, a configuration indicator indicating whether the frequency range which is affected by the IDC problem, or which affects the IDC problem, can be reported at the PRB level, or configuration information necessary to perform the autonomous denial function.

If the configuration indicator(s) or configuration information is included in the idc-AssistanceConfig IE, the UE may report information corresponding to the indicator or perform the function corresponding thereto.

The configuration information necessary to perform the autonomous denial function in the disclosure includes the maximum number of uplink slots (autonomousDenialSlots field) in which the UE may conduct autonomous denial, and information regarding the time interval (autonomousDenial Validity field) during which the autonomous denial slot can be counted. An uplink slot may be used as the unit indicating the autonomous denial validity. If the IDC problem occurs, the UE may pause predetermined uplink transmission up to a preconfigured maximum slot during the number of slots indicated by the field autonomousDenial Validity in order to remove or mitigate the IDC problem. The gNB may provide the autonomous denial configuration information with regard to each cell group (CG). The ASN.1 format of the autonomousDenialSlots and autonomousDenial Validity is given below, wherein the same includes an autonomousDenialSlots configuration value, n2 refers to two slots, n5 refers to five slots, the same includes an autonomousDenial Validity configuration value, and n200 refers to 200 slots. TABLE 1 shows autonomous denial parameters.

TABLE 1
Autonomous denial parameters

| | |
|---|---|
| autonomousDenialParameters-r18 | SEQUENCE { |
| autonomousDenialSlots-r18 | ENUMERATED { n2, n5, n10, n15, |

n20, n30, spare2, spare1},

| | |
|---|---|
| autonomousDenialValidity-r18 | ENUMERATED { n200, n500, n1000, |

n2000, spare4, spare3, spare2, spare1}

In operation 1e-25, the UE 1e-05 may identify the occurrence of the IDC problem with regard to a predetermined mobile communication frequency. For example, uplink transmission signals at the NR frequency may interfere with other communication schemes in the UE, or transmission signals in other communication schemes may interfere with mobile communication frequencies in the UE.

In operation 1e-35, the UE 1e-05 may then perform an autonomous denial operation according to the existing configuration in order to solve the aperiodic IDC interference problem. The number of slots indicating a validity time according to the preconfigured autonomousDenial Validity may be counted according to the following options.

Option 1: in order to avoid IDC interference, the UE starts to count the number of slots indicated by autonomousDenial Validity from the first slot in which uplink transmission is autonomously denied. The UE may pause uplink transmission as many slots as indicated by autonomousDenialSlots until the number of slots indicated by autonomousDenial Validity is all counted. If the number of slots indicated by autonomousDenial Validity is all counted, the count of the number of slots indicated by autonomousDenial Validity and the number of paused uplink slots are all reset. Thereafter, the UE may start to count the number of slots indicated by autonomousDenial Validity from the first slot in which uplink transmission is autonomously denied, and may again pause uplink transmission as many slots as indicated by autonomousDenialSlots.

Option 2: in order to avoid IDC interference, the UE starts to count the number of slots indicated by autonomousDenial Validity from the first slot in which uplink transmission is autonomously denied. The UE may pause uplink transmission as many slots as indicated by autonomousDenialSlots until the number of slots indicated by autonomousDenial Validity is all counted. If the number of slots indicated by autonomousDenial Validity is all counted, the UE may pause any further uplink transmission.

Option 3: the UE starts to count the number of slots indicated by autonomousDenial Validity from a predetermined timepoint, for example, a timepoint at which autonomousDenial Validity configuration information is received and applied. During the counting, the UE may pause uplink transmission as many slots as indicated by autonomousDenialSlots, in order to avoid IDC interference. If the number of slots indicated by autonomousDenial Validity is all counted, the count of the number of slots indicated by autonomousDenial Validity and the number of paused uplink slots are all reset. The UE may again start to count the number of slots indicated by autonomousDenial Validity and may again pause uplink transmission as many slots as indicated by autonomousDenialSlots.

Option 4: the UE starts to count the number of slots indicated by autonomousDenial Validity from a predetermined timepoint, for example, a timepoint at which autonomousDenial Validity configuration information is received and applied. During the counting, the UE may pause uplink transmission as many slots as indicated by autonomousDenialSlots, in order to avoid IDC interference. If the number of slots indicated by autonomousDenial Validity is all counted, the UE may pause any further uplink transmission.

FIG. 1F illustrates a method for operating a bandwidth part (BWP) in a next-generation mobile communication system according to an embodiment of the present disclosure.

In the next-generation mobile communication system, bandwidth parts (BWPs) 1f-05, 1f-10, and 1f-15 having predetermined frequency bands are introduced for respective serving cells. The base station may configure a maximum of four BWPs for each component carrier (CC) through an RRC message, and may activate and use one BWP at one moment. The BWP to be activated and used may be dynamically changed through downlink control information (DCI) or radio resource control (RRC).

Each BWP has a predetermined frequency band, and the sub-carrier spacing (SCS) applied in the BWP may differ. For example, if one CC has a frequency band of 100 MHz, the BWP configured in the CC may have a predetermined frequency band within the 100 MHZ, and one of SCSs supported in next-generation mobile communication systems may be applied to the BWP. Respective BWPs in the CC may have different locations, and the frequency band occupied by each BWP may partially or entirely overlap that of another BWP. Since a different SCS may be applied to each BWP, each BWP may have a different slot length which is inversely proportional to the SCS. In order to distinguish each BWP, a predetermined BWP ID is assigned thereto when the base station configures the same, and the BWP having a BWP ID of 0 is particularly referred to as an initial BWP. The initial BWP is applied when the UE performs initial access.

FIG. 1G illustrates a case in which the effect of autonomous denial varies depending on the bandwidth part (BWP) according to an embodiment of the present disclosure.

The autonomous denial parameters provided for each cell group (CG) (which may include a master cell group (MCG) or secondary cell group (SCG)) are all indicated at the slot level. Therefore, identical parameter values are applied to BWPs of all CCs belonging to one CG, but the actual time indicated by the parameters may differ. For example, assuming that four BWPs are configured for one serving cell, BWP 0 1g-05 (initial BWP) and BWP 1 1g-10 have the same slot length, which is different from that of BWP 2 1g-15 and BWP 1g-20. This means that the time during which an autonomous denial operation may be performed to avoid IDC interference may differ depending on the BWP used during the time and the SCS applied to the BWP.

For example, it will be assumed that, when two slots are configured as autonomous denial slots, IDC interference 1g-30 occurred during a predetermined time interval as illustrated. If BWP 0, BWP 1, and BWP 3 were being used when the IDC interference occurred, an autonomous denial operation (that is, stopping uplink transmission related to IDC interference) may be performed for a sufficient time to avoid the IDC interference problem. However, in the case of BWP 2, which has a relatively small slot length, the autonomous denial operation is to be stopped although the IDC interference still occurs.

An embodiment according to the disclosure provides methods for applying the autonomous denial slot and the validity time, which are derived differently with regard to each CC's BWP.

FIG. 1H illustrates a first method for calculating the autonomous denial slot according to an embodiment of the present disclosure.

In the first method for calculating the autonomous denial slot, the slot length of a bandwidth part (BWP) currently activated and used in one serving cell is applied. During an autonomous denial operation, if the currently used BWP is replaced with another BWP, or if the configuration of the existing BWP is changed (for example, SCS change), the UE may apply the changed slot length, thereby counting the autonomous denial slot. That is, one slot of the currently used BWP may correspond to one slot indicated by the autonomous denial slot.

For example, the base station may configure n5 (that is, five slots) as the configuration value of autonomousDenialSlots and provide the same to the UE. One serving cell has been using BWP 0 1h-05 when IDC interference occurs, and performs an autonomous denial operation at the slot level of BWP 0. When counting the autonomous denial slot at the slot level of BWP 0, the base station switches to BWP 2 at a predetermined timepoint 1h-15. Since IDC interference still occurs, the UE continuously counts the autonomous denial slot at the slot level of BWP 2. The above-mentioned scheme is advantageous in that the applied slot can be recognized intuitively, but is heavily affected by the SCS of the currently used BWP. If the number of slots that are not transmitted according to the autonomous denial operation reaches the configuration value of autonomousDenialSlots, the UE stops the autonomous denial operation regardless of whether IDC interference occurs continuously.

As another embodiment, during an autonomous denial operation, if the currently used BWP is replaced with another BWP, or if the configuration of the existing BWP is changed (for example, SCS change), the UE may reset the autonomous denial slot count and may apply the changed slot length, thereby again counting the autonomous denial slot.

FIG. 1I illustrates a second method for calculating the autonomous denial slot according to an embodiment of the present disclosure.

In the second method for calculating the autonomous denial slot, the slot length of a specific bandwidth part (BWP) of a specific serving cell is applied. Therefore, the slot of a specific BWP of a specific serving cell may serve as a reference slot. The specific serving cell and the specific BWP may be predefined, the specific serving cell may be each CG's SpCell (PCell or PSCell), and the specific BWP may be the initial BWP or a BWP (for example, BWP 0) having a specific BWP ID of each serving cell. Therefore, in serving cells and BWPs other than the specific serving cell and the specific BWP, the autonomous denial slot may be counted with reference to the reference slot. During the autonomous denial operation, if the configuration of the specific serving cell or specific BWP is changed (for example, SCS change), the UE may apply the changed slot length, thereby counting the autonomous denial slot.

For example, the base station may configure n5 (that is, five slots) as the configuration value of autonomousDenialSlots and provide the same to the UE. In this regard, the reference slot is the slot applied to the initial BWP 1i-05 of the SpCell. One serving cell has been using BWP 0 1i-05 when IDC interference occurs, and performs an autonomous denial operation at the slot level of BWP 0. When counting the autonomous denial slot at the slot level of BWP 0, the base station switches to BWP 2 1i-10 at a predetermined timepoint 1i-15. Since IDC interference still occurs, the UE continuously counts the autonomous denial slot at the slot level of BWP 0. That is, since the slot length of BWP 0 is twice the slot length of BWP 2, the number of actually counted autonomous denial slots is only by 1 with reference to the reference slot (BWP 0) although autonomous denial has been performed in two slots of BWP 2. Therefore, in BWPs other than the reference slot (BWP 0), the autonomous denial slot is to be derived according to the reference slot, and the total time during which autonomous denial is performed cannot exceed the total time during which autonomous denial may be performed, which is derived according to autonomousDenialSlots with reference to the reference slot.

The above-mentioned scheme is advantageous in that the same is not affected by the SCS of the currently used BWP, but the UE complexity may increase because the autonomous denial slot is to be calculated with reference to the reference slot. If the number of slots that are not transmitted according to the autonomous denial operation reaches the configuration value of autonomousDenialSlots, the UE stops the autonomous denial operation regardless of whether IDC interference occurs continuously.

FIG. 1J illustrates a third method for calculating the autonomous denial slot according to an embodiment of the present disclosure.

In the third method for calculating the autonomous denial slot, the slot length of a specific bandwidth part (BWP) of a specific serving cell configured by the base station is applied. Therefore, the slot of a specific BWP of a specific serving cell configured by the base station may serve as a reference slot. Therefore, in serving cells and BWPs other than the specific serving cell and specific BWP, the autonomous denial slot is counted with reference to the reference slot. During the autonomous denial operation, if the configuration of the specific serving cell or specific BWP is changed (for example, SCS change), the UE may apply the changed slot length, thereby counting the autonomous denial slot.

For example, the base station may configure n5 (that is, five slots) as the configuration value of autonomousDenialSlots, may designate BWP 3 1j-15 of the SpCell as the reference slot, and may provide the same to the UE. One serving cell has been using BWP 0 1j-05 when IDC interference occurs, and performs an autonomous denial operation at the slot level of BWP 3. When counting the autonomous denial slot at the slot level of BWP 3, the base station switches to BWP 2 1j-10 at a predetermined timepoint 1j-20. Since IDC interference still occurs, the UE continuously counts the autonomous denial slot at the slot level of BWP 3. That is, since the slot length of BWP 3 is twice the slot length of BWP 0, the number of actually counted autonomous denial slots is only by 1 with reference to the reference slot (BWP 3) although autonomous denial has been performed in two slots of BWP 0. In addition, since the slot length of BWP 3 is four times the slot length of BWP 2, the number of actually counted autonomous denial slots is only by 1 with reference to the reference slot (BWP 3) although autonomous denial has been performed in four slots of BWP 0. Therefore, in BWPs other than the reference slot (BWP 0), the autonomous denial slot is to be derived according to the reference slot, and the total time during which autonomous denial is performed cannot exceed the total time during which autonomous denial may be performed, which is derived according to autonomousDenialSlots with reference to the reference slot.

The above-mentioned scheme is advantageous in that the same is not affected by the SCS of the currently used BWP, but signaling overhead for additional configuration may occur, and the UE complexity may increase because the autonomous denial slot is to be calculated with reference to the reference slot. If the number of slots that are not transmitted according to the autonomous denial operation reaches the configuration value of autonomousDenialSlots, the UE stops the autonomous denial operation regardless of whether IDC interference occurs continuously.

In another embodiment of the disclosure, the slot of a BWP having the largest or smallest slot length among currently configured or activated BWPs may be defined as the reference slot. Alternatively, the base station may make configuration regarding whether the slot having the largest or smallest length will be applied or not. If a long slot is applied, it is easy to handle a case in which IDC interference occurs for a long time, but the transmission rate performance may be degraded because uplink transmission cannot be performed according to the scheduling during many slots in the case of a BWP having a long SCS. To the contrary, if a short slot is applied, it is difficult to handle a case in which IDC interference occurs for a long time, but degradation in the transmission rate performance is limited because uplink transmission cannot be performed according to the scheduling during few slots even in the case of a BWP having a long SCS.

In another embodiment of the disclosure, a slot corresponding to one of SCSs supported by next-generation mobile communications may be defined as the reference slot. The SCS having the largest or smallest value may also be considered, and the base station may make configuration regarding the slot length corresponding to what SCS value is to be applied. Such a scheme is independent of the influence of the configured BWP.

FIG. 1K illustrates a first method for calculating the autonomous denial validity time according to an embodiment of the present disclosure.

The autonomous denial validity is also configured at the slot level. Therefore, it is to be determined what slot length is to be applied to derive the autonomous denial validity time.

In the first method for calculating the autonomous denial validity time, the slot length of a bandwidth part (BWP) currently activated and used in one serving cell is applied. During an autonomous denial operation, if the currently used BWP is replaced with another BWP, or if the configuration of the existing BWP is changed (for example, SCS change), the UE may apply the changed slot length, thereby counting the autonomous denial validity slot. That is, one slot of the currently used BWP may correspond to one slot indicated by AutonomousDenial Validity.

For example, the UE starts to count the autonomous denial validity slot at a predetermined timepoint described above. When counting the autonomous denial validity slot at the slot level of BWP 0 1k-05, the base station switches to BWP 2 1k-10 at a predetermined timepoint 1k-15. The UE then continuously counts the autonomous denial validity slot at the slot level of BWP 2. The above-mentioned scheme is advantageous in that the applied slot can be recognized intuitively, but is heavily affected by the SCS of the currently used BWP.

As another embodiment of the disclosure, when counting the autonomous denial validity slot, if the currently used BWP is replaced with another BWP, or if the configuration of the existing BWP is changed (for example, SCS change), the UE may reset the autonomous denial validity slot count and may apply the changed slot length, thereby again counting the autonomous denial validity slot.

FIG. 1L illustrates a second method for calculating the autonomous denial validity time according to an embodiment of the present disclosure.

In the second method for calculating the autonomous denial validity time, the slot length of a specific bandwidth part (BWP) of a specific serving cell is applied. Therefore, the slot of a specific BWP of a specific serving cell may serve as a reference slot. The specific serving cell and the specific BWP may be predefined, the specific serving cell may be each CG's SpCell (PCell or PSCell), and the specific BWP may be the initial BWP or a BWP (for example, BWP 0) having a specific BWP ID of each serving cell.

For example, the UE starts to count the autonomous denial validity slot at a predetermined timepoint described above. The UE counts the autonomous denial validity slot at the slot level of BWP 0 1l-05 of the SpCell (reference slot). The base station changes the BWP to be used from BWP 0 1m-05 to BWP 2 1m-10 at a predetermined timepoint 1m-15, but the autonomous denial validity slot count is not affected in any manner.

The above-mentioned scheme is advantageous in that the same is not affected by the SCS of the currently used BWP, but the UE complexity may increase because the autonomous denial slot is to be calculated with reference to the reference slot.

FIG. 1M illustrates a third method for calculating the autonomous denial validity time according to an embodiment of the present disclosure.

In the third method for calculating the autonomous denial validity time, the slot length of a BWP of a specific serving cell configured by the base station is applied. Therefore, the slot of a specific BWP of a specific serving cell configured by the base station may serve as a reference slot. Therefore, in serving cells and BWPs other than the specific serving cell and specific BWP, the autonomous denial validity slot is counted with reference to the reference slot.

For example, the base station may indicate BWP 3 of the SpCell as the reference slot and provide the same to the UE, together with autonomousDenial Validity. The UE starts to count the autonomous denial validity slot at a predetermined timepoint described above. The UE counts the autonomous denial validity slot at the slot level of BWP 3 1m-15 of the SpCell (reference slot). The base station changes the BWP to be used from BWP 0 1m-05 to BWP 2 1m-10 at a predetermined timepoint 1m-15, but the autonomous denial validity slot count is not affected in any manner.

The above-mentioned scheme is advantageous in that the same is not affected by the SCS of the currently used BWP, but signaling overhead for additional configuration may occur, and the UE complexity may increase because the autonomous denial slot is to be calculated with reference to the reference slot.

In another embodiment of the disclosure, the slot of a BWP having the largest or smallest slot length among currently configured or activated BWPs may be defined as the reference slot used to count the autonomous denial validity slot. Alternatively, the base station may make configuration regarding whether a slot having a large or small length will be applied or not. Alternatively, a slot corresponding to one of SCSs supported by next-generation mobile communications may be defined as the reference slot. The SCS having the largest or smallest value may also be considered, and the base station may make configuration regarding the slot length corresponding to what SCS value is to be applied. Such a scheme is independent of the influence of the configured BWP.

Configuration values of the parameters autonomousDenialSlots and autonomousDenial Validity may be provided for each CG. Therefore, when configuring carrier aggregation (CA) technology supporting multiple serving cells belonging to one CG, the base station needs to determine how the above parameters will be applied to respective serving cells.

Option 1: configuration values of autonomousDenialSlots and autonomousDenial Validity are configured for each CG, but the UE performs an autonomous denial operation so as to be applied to each serving cell according to the above-described method. Therefore, an autonomous denial operation is performed independently to avoid IDC interference in each serving cell. Accordingly, the number of autonomous denial slots and autonomous denial validity slots counted in each serving cell may differ.

Option 2: configuration values of autonomousDenialSlots and autonomousDenial Validity are configured for each CG, but the UE performs an autonomous denial operation so as to be applied to each time advance group (TAG) according to the above-described method. That is, the UE counts one autonomous denial slot each time one serving cell belonging to one TAG stops transmission in one slot (with reference to the reference slot in the above method) to avoid IDC interference. If one or more serving cells stopped uplink transmission at an identical timepoint, the UE may count one autonomous denial slot. As used herein, the identical timepoint may include a case in which a time interval overlaps between all or some of synchronized slots.

Option 3: configuration values of autonomousDenialSlots and autonomousDenial Validity are configured for each CG, but the UE performs an autonomous denial operation so as to be applied to each CG according to the above-described method. That is, the UE counts one autonomous denial slot each time one serving cell belonging to one CG stops transmission in one slot (with reference to the reference slot in the above method) to avoid IDC interference. If one or more serving cells stopped uplink transmission at an identical timepoint, the UE may count one autonomous denial slot. As used herein, the identical timepoint may include a case in which a time interval overlaps between all or some of synchronized slots.

FIG. 1N illustrates a flowchart of UE operations according to an embodiment of the present disclosure.

In operation 1n-05, the UE may report, to the base station, that the UE is capable of reporting the predetermined IDC information.

In operation 1n-10, the UE may receive an RRC reconfiguration (or RRCReconfiguration) message from the base station. The RRC reconfiguration message may contain an OtherConfig IE including an idc-AssistanceConfig IE. The IE idc-AssistanceConfig may include parameters autonomousDenialSlots and autonomousDenial Validity.

In operation 1n-15, the UE may determine whether the UE is undergoing the IDC problem.

In operation 1n-20, the UE may pause predetermined uplink transmission according to configuration information of autonomousDenialSlots and autonomousDenial Validity.

FIG. 1O illustrates a flowchart of base station operations according to an embodiment of the present disclosure.

In operation 1o-05, the base station may receive UE capability information from the UE.

In operation 1o-10, the base station may transmit an IE otherConfig including an idc-AssistanceConfig field to the UE. The IE idc-AssistanceConfig may include parameters autonomousDenialSlots and autonomousDenial Validity.

FIG. 1P illustrates an internal structure of a UE according to an embodiment of the present disclosure.

Referring to FIG. 1P, the UE may include a radio frequency (RF) 1p-10, a baseband 1p-20, a storage 1p-30, and a controller 1p-40.

The RF 1p-10 performs functions for transmitting/receiving signals through a radio channel, such as signal band conversion and amplification. That is, the RF 1p-10 up-converts a baseband signal provided from the baseband 1p-20 to an RF band signal, transmits the same through an antenna, and down-converts an RF band signal received through the antenna. For example, the RF 1p-10 may include a transmission filter, a reception filter, an amplifier, a mixer, an oscillator, a digital-to-analog converter (DAC), and an analog-to-digital converter (ADC) and the like. Although only one antenna is illustrated in FIG. 1P, the UE may include multiple antennas. In addition, the RF 1p-10 may include multiple RF chains. Furthermore, the RF 1p-10 may perform beamforming. For the beamforming, the RF 1p-10 may adjust the phase and magnitude of signals transmitted/received through multiple antennas or antenna elements, respectively. In addition, the RF 1p-10 may perform MIMO, and may receive multiple layers when performing a MIMO operation.

The baseband 1p-20 performs functions of conversion between baseband signals and bitstrings according to the system's physical layer specifications. For example, during data transmission, the baseband 1p-20 encodes and modulates a transmitted bitstring to generate complex symbols. In addition, during data reception, the baseband 1p-20 demodulates and decodes a baseband signal provided from the RF 1p-10 to restore a received bitstring. For example, when following the orthogonal frequency division multiplexing (OFDM) scheme, during data transmission, the baseband 1p-20 encodes and modulates a transmitted bitstring to generate complex symbols, maps the complex symbols to subcarriers, and configures OFDM symbols through inverse fast Fourier transform (IFFT) operation and cyclic prefix (CP) insertion. In addition, during data reception, the baseband 1p-20 splits a baseband signal provided from the RF 1p-10 at the OFDM symbol level, restores signals mapped to subcarriers through fast Fourier transform (FFT) operation, and restores a received bitstring through demodulation and decoding.

The baseband 1p-20 and the RF 1p-10 transmit and receive signals as described above. Therefore, the baseband 1p-20 and the RF 1p-10 may be referred to as a transmitter, a receiver, a transceiver, or a communication circuit. Furthermore, at least one of the baseband 1p-20 and the RF 1p-10 may include multiple communication modules to support multiple different radio access technologies. In addition, at least one of the baseband 1p-20 and the RF 1p-10 may include different communication modules to process signals in different frequency bands. For example, the different radio access technologies may include wireless LANs (for example, IEEE 802.11), cellular networks (for example, LTE), and the like. In addition, the different frequency bands may include a super high frequency (SHF) (for example, 2.NRHz, NRhz) bands and millimeter wave (for example, 60 GHz) bands.

The storage 1p-30 stores data such as basic programs for operation of the UE, application programs, configuration information. Particularly, the storage 1p-30 may store information related to a second access node which performs radio communication by using a second radio access technology. In addition, the storage 1p-30 provides the stored data at the request of the controller 1p-40.

The controller 1p-40 controls overall operations of the UE. For example, the controller 1p-40 transmits/receives signals through the baseband 1p-20 and the RF 1p-10. In addition, the controller 1p-40 records and reads data in the storage 1p-40. To this end, the controller 1p-40 may include at least one processor. For example, the controller 1p-40 may include a communication processor (CP) configured to perform control for communication, and an application processor (AP) configured to control upper layers such as application programs.

FIG. 1Q illustrates a configuration of a base station according to an embodiment of the present disclosure.

Referring to FIG. 1Q, the base station may include an RF 1q-10, a baseband 1q-20, a backhaul communication circuit 1q-30, a storage 1q-40, and a controller 1q-50.

The RF 1q-10 performs functions for transmitting/receiving signals through a radio channel, such as signal band conversion and amplification. That is, the RF 1q-10 up-converts a baseband signal provided from the baseband 1q-20 to an RF band signal, transmits the same through an antenna, and down-converts an RF band signal received through the antenna to a baseband signal. For example, the RF 1q-10 may include a transmission filter, a reception filter, an amplifier, a mixer, an oscillator, a DAC, and an ADC. Although only one antenna is illustrated in FIG. 1Q, the first access node may include multiple antennas. In addition, the RF 1q-10 may include multiple RF chains. Furthermore, the RF 1q-10 may perform beamforming. For the beamforming, the RF 1q-10 may adjust the phase and magnitude of signals transmitted/received through multiple antennas or antenna elements, respectively. The RF 1q may transmit one or more layers to perform a downward MIMO operation.

The baseband 1q-20 performs functions of conversion between baseband signals and bitstrings according to the physical layer specifications of first radio access technology. For example, during data transmission, the baseband 1q-20 encodes and modulates a transmitted bitstring to generate complex symbols. In addition, during data reception, the baseband 1q-20 demodulates and decodes a baseband signal provided from the RF 1q-10 to restore a received bitstring. For example, when following the OFDM scheme, during data transmission, the baseband 1q-20 encodes and modulates a transmitted bitstring to generate complex symbols, maps the complex symbols to subcarriers, and configures OFDM symbols through IFFT operation and CP insertion. In addition, during data reception, the baseband 1q-20 splits a baseband signal provided from the RF 1q-10 at the OFDM symbol level, restores signals mapped to subcarriers through FFT operation, and restores a received bitstring through demodulation and decoding. The baseband 1q-20 and the RF 1q-10 transmit and receive signals as described above. Therefore, the baseband 1q-20 and the RF 1q-10 may be referred to as a transmitter, a receiver, a transceiver, a communication circuit, or a wireless communication circuit.

The backhaul communication circuit 1q-30 provides an interface for communicating with other nodes in the network. That is, the backhaul communication circuit 1q-30 converts bitstrings transmitted from the main base station to other nodes (for example, auxiliary base station, core network, and the like) to physical signals, and converts physical signals received from the other nodes to bitstrings.

The storage 1q-40 stores data such as basic programs for operation of the main base station, application programs, configuration information. Particularly, the storage 1q-40 may store information regarding a bearer allocated to a connected UE, a measurement result reported from the connected UE, and the like. In addition, the storage 1q-40 may store information serving as a reference to determine whether to provide multi-connection to a UE or to suspend the same. In addition, the storage 1q-40 provides the stored data at the request of the controller 1q-50.

The controller 1q-50 controls overall operations of the main base station. For example, the controller 1q-50 transmits/receives signals through the baseband 1q-20 and the RF 1q-10 or through the backhaul communication circuit 1q-30. In addition, the controller 1q-50 records and reads data in the storage 1q-40. To this end, the controller 1q-50 may include at least one processor.

When implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

The embodiments of the disclosure described and shown in the specification and the drawings are merely specific examples that have been presented to easily explain the technical contents of the disclosure and help understanding of the disclosure, and are not intended to limit the scope of the disclosure. It will be apparent to those skilled in the art that, in addition to the embodiments disclosed herein, other variants may be implemented based on the technical idea of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) supporting an autonomous denial in a wireless communication system, the method comprising:
receiving, from a base station, cell group configuration information including first information indicating a maximum number of uplink (UL) slots for denying an UL transmission;
counting a number of denied UL slots within a same cell group; and
in case that the counted number of denied UL slots is less than the first information, determining to deny any transmission in a UL slot.

2. The method of claim 1, wherein counting the number of the denied UL slots comprising:
summing up the denied UL slots across all serving cells within the same cell group.

3. The method of claim 2, wherein in case that multiple denied UL slots across all serving cells partially or fully overlap in a time domain, the number of denied UL slots across all serving cells is counted as one denied UL slot.

4. The method of claim 3, wherein the number of denied UL slots across all serving cells is counted as one denied UL slot based on a longest slot.

5. The method of claim 1, wherein the cell group configuration information further includes second information indicating a validity period over which UL autonomous denial slots is counted.

6. A method performed by a base station supporting an autonomous denial in a wireless communication system, the method comprising:
generating cell group configuration information including first information indicating a maximum number of uplink (UL) slots for denying an UL transmission;
transmitting, to a user equipment (UE), the cell group configuration information including the first information; and
in case that a counted number of denied UL slots is less than the first information, skipping to receive the UL transmission,
wherein the number of denied UL slots is counted within a same cell group.

7. The method of claim 6, wherein the denied UL slots are summed up across all serving cells within a same cell group.

8. The method of claim 7, wherein in case that multiple denied UL slots across all serving cells partially or fully overlap in a time domain, the number of denied UL slots across all serving cells is counted as one denied UL slot.

9. The method of claim 8, wherein the number of denied UL slots across all serving cells is counted as one denied UL slot based on a longest slot.

10. The method of claim 6, wherein the cell group configuration information further includes second information indicating a validity period over which UL autonomous denial slots is counted.

11. A user equipment (UE) supporting an autonomous denial in a wireless communication system, the UE comprising:
a transceiver; and
a controller operably coupled to the transceiver, the controller configured to:
receive, from a base station, cell group configuration information including first information indicating a maximum number of uplink (UL) slots for denying an UL transmission,
count a number of denied UL slots within a same cell group, and
in case that the counted number of denied UL slots is less than the first information, determine to deny any transmission in UL transmission in a UL slot.

12. The UE of claim 11, wherein the controller is further configured to:
sum up the denied UL slots across all serving cells within a same cell group.

13. The UE of claim 12, wherein, in case that multiple denied UL slots across all serving cells partially or fully overlap in a time domain, the number of denied UL slots across all serving cells is counted as one denied UL slot.

14. The UE of claim 13, wherein the number of denied UL slots across all serving cells is counted as one denied UL slot based on a longest slot.

15. The UE of claim 11, wherein the cell group configuration information further includes second information indicating a validity period over which UL autonomous denial slots is counted.

16. A base station supporting an autonomous denial in a wireless communication system, the base station comprising:
a transceiver; and
a controller operably coupled to the transceiver, the controller configured to:
generate cell group configuration information including first information indicating a maximum number of uplink (UL) slots for denying an UL transmission,
transmit, to a user equipment (UE), the cell group configuration information including the first information, and
in case that a counted number of denied UL slots is less than the first information, skip to receive the UL transmission,
wherein the number of denied UL slots is counted within a same cell group.

17. The base station of claim 16, wherein the denied UL slots are summed up across all serving cells within a same cell group.

18. The base station of claim 17, wherein in case that multiple denied UL slots across all serving cells partially or fully overlap in a time domain, the number of denied UL slots across all serving cells is counted as one denied UL slot.

19. The base station of claim 18, wherein the number of denied UL slots across all serving cells is counted as one denied UL slot based on a longest slot.

20. The base station of claim 16, wherein the cell group configuration information further includes second information indicating a validity period over which UL autonomous denial slots is counted.
